(19) United States
(12) Patent Application Publication
(10) Pub. No.: US 2012/0203817 A1
(43) Pub. Date: Aug. 9, 2012

(54) Data stream management system for accessing mass data and method thereof

(75) Inventor: Ta-Hsiung Hu, Taipei City (TW)

(73) Assignee: Kinghood Technology Co., Ltd., Taipei (TW)

(21) Appl. No.: 13/137,271

(22) Filed: Aug. 3, 2011

(30) Foreign Application Priority Data
Feb. 8, 2011 (TW) 100104126

(51) Int. Cl. G06F 15/16

(52) U.S. Cl. 709/201

(57) ABSTRACT

A data stream management system for accessing mass data and method thereof is disclosed. The system includes: a client computer and a number of distributed server groups. The client computer and the distributed server groups are connected via network. Each of the distributed server groups including: a determination unit, a dividing unit, a transmitting unit, a number of distributed servers and a dispatching server. The system divides a main data into a number of data sections and stores them in the distributed servers of different distributed server groups. The system can quickly integrate the distributed data sections back into the main data by uses of a global index.

### FIELD OF THE INVENTION

The present invention relates generally to a data stream management system. More particularly, the present invention relates to a data stream management system for accessing mass data between different distributed server groups.

### BACKGROUND OF THE INVENTION

Recently, video/audio server systems are getting popular due to growth of network and multimedia industry. By use of streaming technology, video/audio files can be transmitted and browsed at the same time. Furthermore, a link can also be inserted into the streamed video/audio file such that website can automatically change pages during playback of the video/audio. By use of this kind of server system, mass video/audio data stream can be transmitted to many clients at low cost. Due to digital wideband, users can easily watch/listen to video/audio on demand (video-on-demand) without waiting for a long time. However, even though the bandwidth of network is large enough, it is still hard for current network server systems to efficiently and exquisitely provide such services while many users request to obtain a certain video file (e.g., an network real time baseball game) at the same time.

Sizes of multimedia files are usually huge. For example, a movie may have a size of 5 billion bytes, and to playback a television program usually may require a transmission rate of 200 million bytes per second. Furthermore, if every user can select a video stream from a video stream database including 10¹⁴ bytes (e.g., 10 billion bytes per program multiplied by 1000 programs) and continuously playback the selected video at a transmission rate of 200 million bytes per second, and every program may expectably be provided to thousands of users, then a system that can efficiently transmit the video stream at low cost is desperately needed to fulfill user's non-endless demands.

Certain complex problems need to be put into consideration while designing such system, or else those problems may be even harder to solve afterwards. Demands for a program may differ from program to program, and therefore, can not be considered having the same amount of demands. For example, some programs are more popular than others which has a larger ratio of clients requesting for watching thereof. Hence, if every program is evenly dispatched to every server, then capacity for every program may be limited, such that demand for the popular program may not be satisfied.

Some prior arts provide solutions for the aforementioned problems. Please refer to FIG. 1, FIG. 1 illustrates a peer-to-peer broadcasting scheme (PPBS). Such scheme uses a harmonic broadcasting scheme for performing the peer-to-peer broadcasting of video/audio stream. PPBS assume that every peer on the network has a close distance, and every peer is synchronized by a same clock. As long as the peer is on the network, it can broadcast video/audio streams. Thus, every channel can be replaced by a peer server group in the harmonic broadcasting scheme. Only one peer of a channel is in charge of broadcasting the video/audio stream to a receiver at the same time. In other words, N different peers of N channels can be used for broadcasting. Because the peer server groups will confirm whether each of which is at normal service status, a peer of a second priority peer server group will immediately replace the peer of channel i while problem occurs to remain stability of the system. If the second priority peer occur problem at the meantime, then a third or fourth priority peer will take over. However, such method has a few problems: First, assumption that every peer on the network has a close distance is not realistic. In practice, companies or individuals that provide stream service may globally receive demands from different domains (e.g., selection of a US network video/audio service from an Asia country), and the peers are located separately. Next, the calculation method for replacement priority may not satisfy the immediate need of the users. Furthermore, in the aforementioned circumstance, it is not the fastest way for broadcasting video/audio streams to users by only allowing one peer of a channel to be in charge thereof.

Please refer to FIG. 2. It illustrates another prior art which provides a method for content transmission by clustering peers into a hierarchical tree structure for easy and efficient management. The tree has a height O (log n) logarithmic with the number of clients. The lowest level includes all of the peers of the upper levels, and therefore, when a receiver of a peer wants to obtain a data stream, it will request to a head peer of an upper level for the data stream. Due to the hierarchical tree structure, effect to the whole network caused by absent of a peer can be limited. Every tree stem has a representative for representing peers which are under stream distribution during query of sub-clusters. When a peer can perform streaming, then distribution will be performed by a head of the cluster. Obviously, a disadvantage of this kind of streaming method is that distribution of the data stream from the head peer to the non-head peers are not optimized, such that it is quite consuming for system resources while network stream data flow is large.

Finally, please refer to FIG. 3. It illustrates a direct streaming method of a peer-to-peer data stream system based on an index. A newly added client peer requests for entry status of each cluster from an index server, and the index server will reply a list of peers which can provide data streams starting from a certain playback point, then the client peer can directly ask the peer in the cluster for allowance of entrance to the cluster. The direct stream structure also provides recording and playback functions. A user can know from which cluster or stream server to obtain any playback point of a movie by asking the index server. Due to the fact that there are none peer-to-peer contact information between each cluster, distribution of stream data of each cluster can not be even, and therefore, streaming rate may differ depending on the clusters connected thereto.

Hence, a data stream management system that can efficiently distribute and obtain data stream in a short time and can provide more data sources for popular data (video/audio file) is desperately needed.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In accordance with an aspect of the present invention, a data stream management system for accessing mass data includes: a client computer, for transmitting and receiving a main data; and a plurality of distributed server groups, connected to the client computer via network. Each of the distributed server groups includes: a determination unit, for determining whether size of the main data from the client computer exceeds a predetermined size; a dividing unit, for dividing the main data into a plurality of data sections in a unit of the predetermined size and numbering the data sections into different section numbers while size of the main data exceeds the predetermined size, wherein the main data is considered as one date section while size of the main data is smaller than the predetermined size; a plurality of distributed servers, for storing the data sections; a transmitting unit, for transmitting the data sections to different distributed servers; and a dispatching server, for controlling access of the distributed servers, and storing a global index for identifying in which distributed server each data sections is located.

Preferably, the distributed server group further includes an updating unit, for updating the global index of the distributed server group therein, and transmitting the updated global index to other updating units of other distributed server groups.

Preferably, the updating unit updates the global index while the main data is transmitted or received by the client computer.

Preferably, the updating unit updates the global index regularly.

Preferably, the data section is distributed in different distributed servers of the distributed server groups.

Preferably, the data section is randomly distributed in different distributed servers.

Preferably, the data stream management system further includes an integrating unit, for locating each data sections of the main data based on the global index, selecting a distributed server to access by a specific condition, and integrating each data sections of the main data in sequence before providing to the client computer while the client computer requests to receive the main data.

Preferably, the specific condition includes transmission rate and completeness of the data sections.

Preferably, the data stream management system further includes a proxy server having a memory, for accessing each data sections of the main data from the distributed server based on the global index, storing each data sections of different section numbers to the memory, and integrating each data sections of the main data in sequence by section numbers before providing to the client computer while the client computer requests to receive the main data.

Preferably, the main data is a video/audio file.

Preferably, the global index includes at least one data section array.

In accordance with another aspect of the present invention, a method for accessing mass data by a data stream management system as aforementioned includes the following steps: a) transmitting a main data; b) determining whether the size of the main data exceeds a predetermined size; c) dividing the main data into a plurality of data sections in a unit of the predetermined size and numbering the data sections into different section numbers while size of the main data exceeds the predetermined size, wherein the main data is considered as one date section while size of the main data is smaller than the predetermined size; d) transmitting the data sections to different distributed servers; and e) updating a current location of each data sections in a global index.

Preferably, the method further includes the following steps: f) locating each data sections of the main data based on the global index while obtaining a request to receive the main data; g) selecting a distributed server to access by a specific condition; and h) integrating each data sections of the main data in sequence by section numbers.

Preferably, the specific condition includes transmission rate and completeness of the data sections.

Preferably, the method further includes between steps g) and h) a step of storing each data sections of different section numbers.

Preferably, the global index includes at least one data section array.

### BRIEF DESCRIPTION OF THE DRAWINGS

FIG. 1 shows a first prior art.

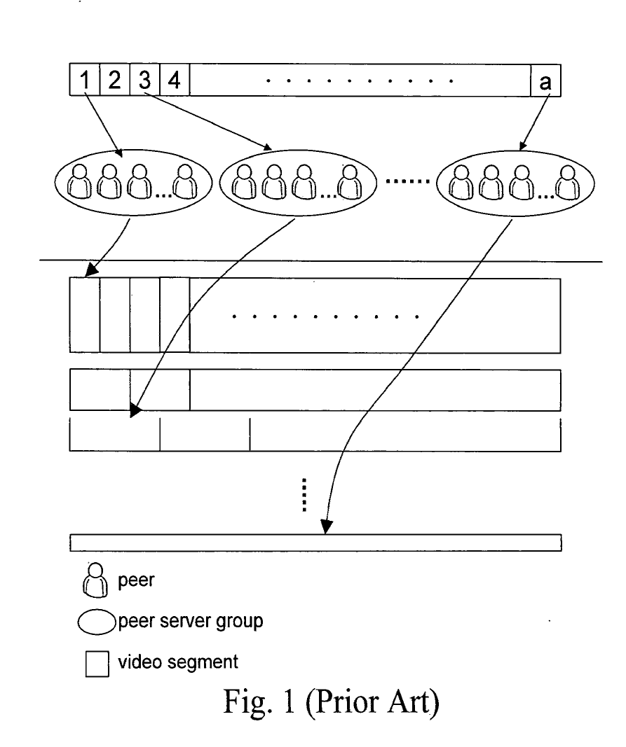

FIG. 2 shows a second prior art.

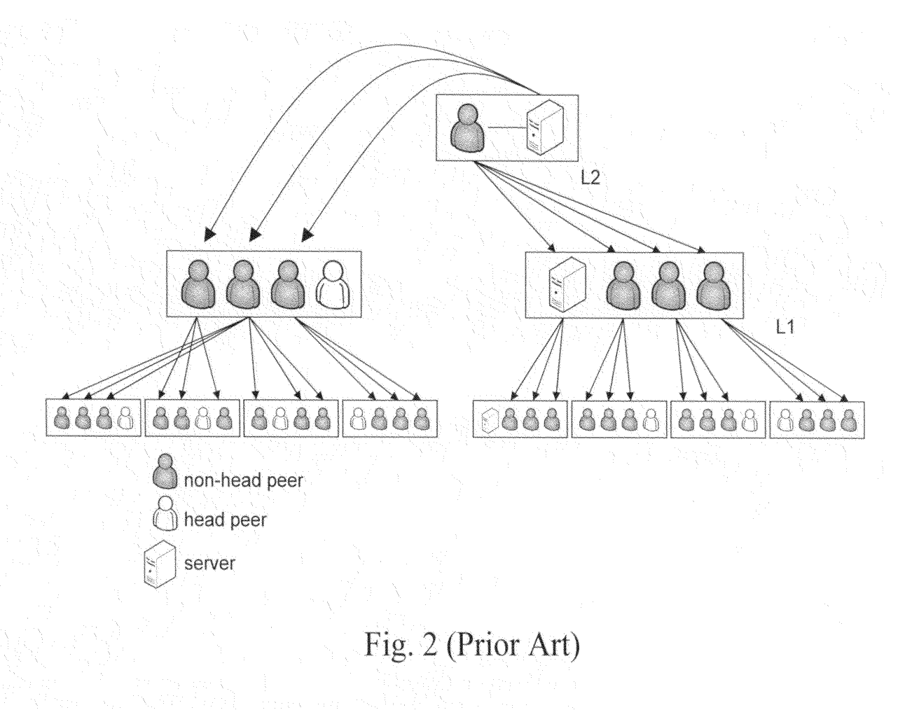

FIG. 3 shows a third prior art.

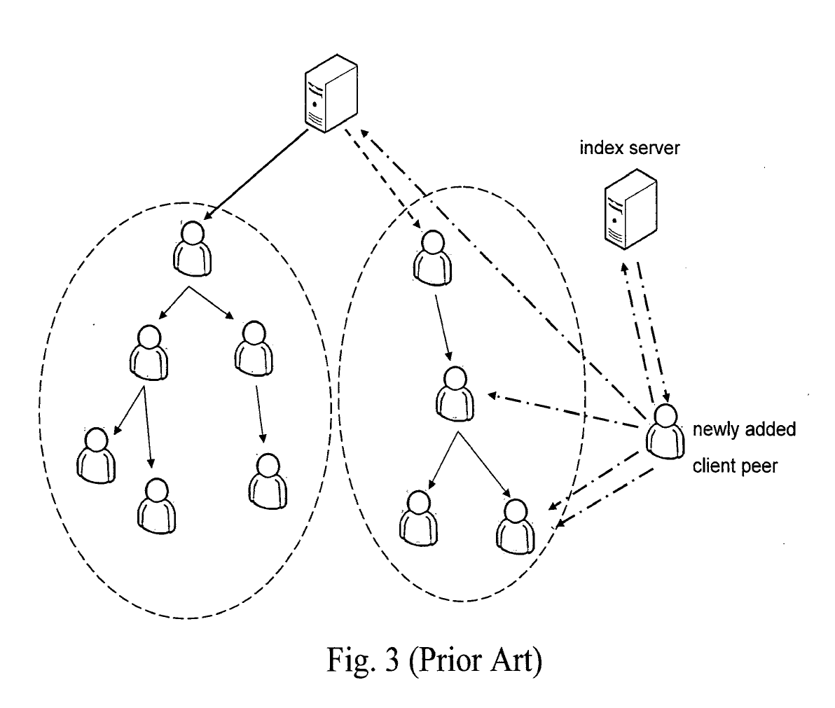

FIG. 4 shows an embodiment of the present invention.

FIG. 5 shows a data section transmitting method according to the present invention.

FIG. 6 shows another data section transmitting method according to the present invention.

FIG. 7 is a flow chart showing a method for storing mass data according to the present invention.

FIG. 8 is a flow chart showing a method for browsing mass data according to the present invention.

### DETAILED DESCRIPTION OF THE PREFERRED EMBODIMENT

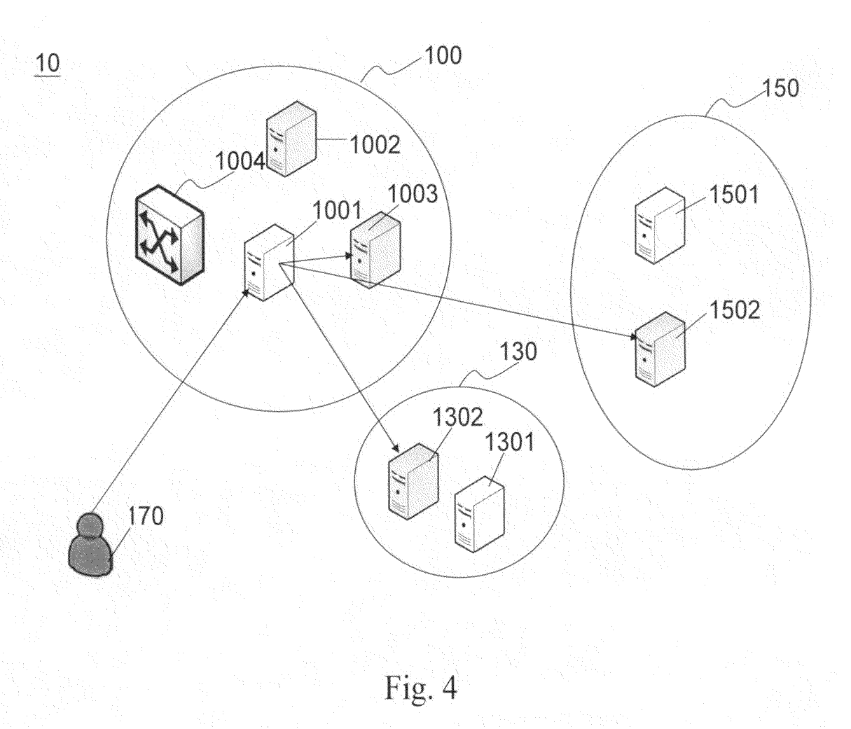

Please refer to FIGS. 4 to 8. FIG. 4 shows a data stream management system for accessing mass data according to an embodiment of the present invention. The data stream management system 10 includes a first distributed server group 100, a second distributed server group 130 and a third distributed server group 150. According to the present embodiment, the amount of groups includes at least two. Transmission and reception of a main data (e.g., video/audio file), is executed by a client computer 170, and is connected to each of the aforementioned distributed server groups 100, 130 and 150 via network. The client computer 170 is considered client end, and the distributed server groups 100, 130 and 150 are considered system end. The client end and the system end are connected via network.

In the present embodiment, the first distributed server group 100 includes servers 1001, 1002, 1003 and 1004; the second distributed server group 130 includes servers 1301 and 1302; the third distributed server group 150 includes servers 1501 and 1502, wherein servers 1001, 1301 and 1501 are main servers.

The main servers 1001, 1301 and 1501 have the following functions: 1. Determining function: for determining whether size of the main data from the client computer 170 exceeds a predetermined size. 2. Dividing function: for dividing the main data into a number of data sections in a unit of the predetermined size and numbering the data sections into different section numbers while size of the main data exceeds the predetermined size. Furthermore, the main servers 1001, 1301 and 1501 will consider the main data as one data section while size of the main data is smaller than the predetermined size. 3. Transmitting function: for transmitting the data sections to different servers. Due to the aforementioned functions, servers 1001, 1301 and 1501 each act as a dispatching server in the distributed server groups 100, 130 and 150, which controls access of the data sections between the servers 1002, 1003, 1004, 1302, 1502 and the main servers 1001, 1301 and 1501. Moreover, the main servers 1001, 1301 and 1501 each has a global index stored therein for identifying in which distributed server each data section is located. The global index includes at least one data section array. Servers 1002, 1003, 1004, 1302 and 1502 stores and provides the data sections after receiving broadcasting notice from the main servers 1001, 1301 and 1501.

Main servers 1001, 1301 and 1501 also includes an update function, for updating the global index of the distributed server group therein, and transmitting the updated global index to other main servers of other distributed server groups. Update is performed while the main data is transmitted or received by the client computer 170. Alternatively, the global indexes of the main servers 1001, 1301 and 1501 can be configured to update regularly. Furthermore, the data sections that can be randomly or systematically distributed in different/same distributed server of different/same distributed server groups.

Main servers 1001, 1301 and 1501 further includes an integrating function. The main servers 1001, 1301 and 1501 can locate each data sections of the main data based on the global index, and then select a server to access by a specific condition. Later, each data sections of the main data is integrated in sequence before providing to the client computer 170 while the client computer 170 requests to receive the main data. In this embodiment, the specific condition includes transmission rate and completeness of the data sections. In other words, the main servers 1001, 1301 and 1501 will base on the global index select a server which provides the highest network transmission rate or includes most complete data sections (i.e., having the most data sections for integrating into the main data) of the main data for accessing the data sections.

In this embodiment, server 1004 acts as a proxy server (hereinafter called proxy server 1004). The proxy server 1004 has a memory (not shown). The proxy server 1004 accesses each data sections of the main data from the distributed server based on the global index, and stores each data sections of different section numbers to the memory. Then, the proxy server 1004 integrates each data sections of the main data in sequence by section numbers before providing to the client computer 170 while the client computer 170 requests to receive the main data.

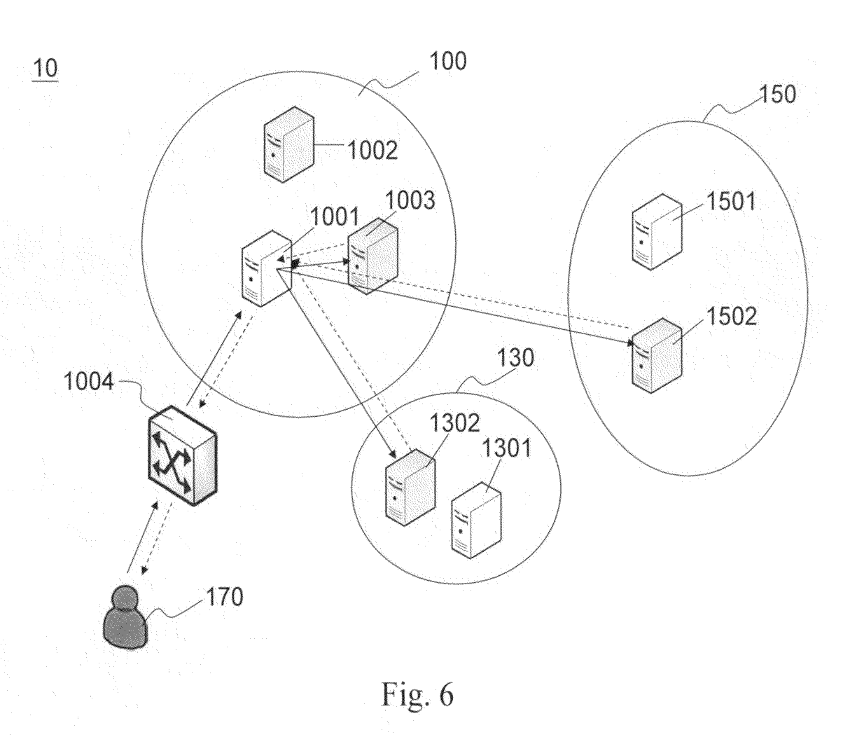

Even though server 1004 acts as a proxy server in this embodiment, the proxy server is not limited to be in distributed server groups 100, 130 or 150, it can be in the client computer 170 or be externally connected to the client computer 170, as shown in FIG. 6. Furthermore, the client computer 170 can even act as a proxy server according to the present invention. In other words, integration of each data sections of the main data in sequence by section numbers can be performed not only at the system end, but also at the client end.

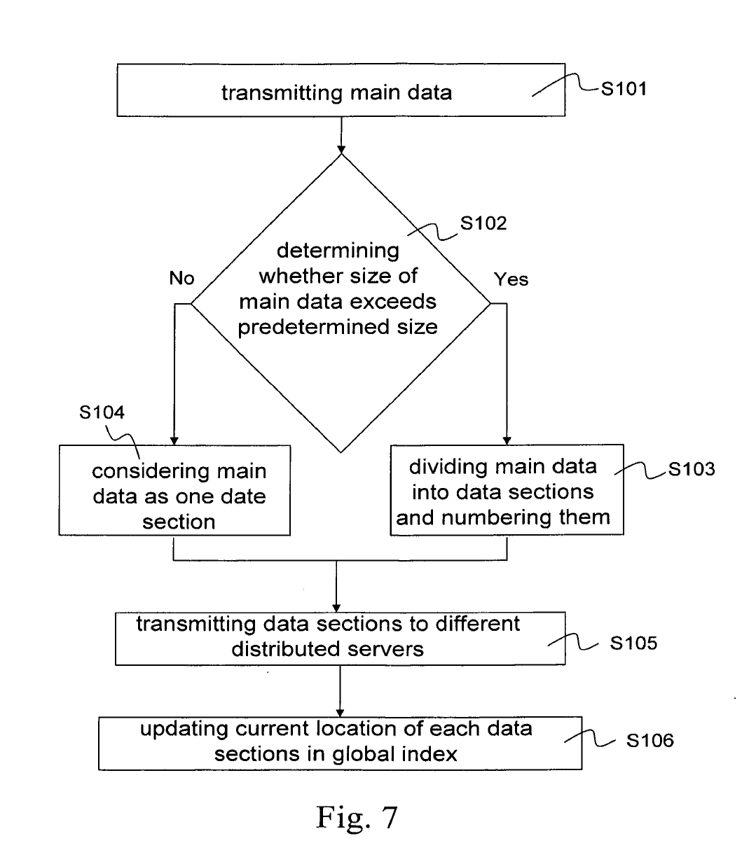

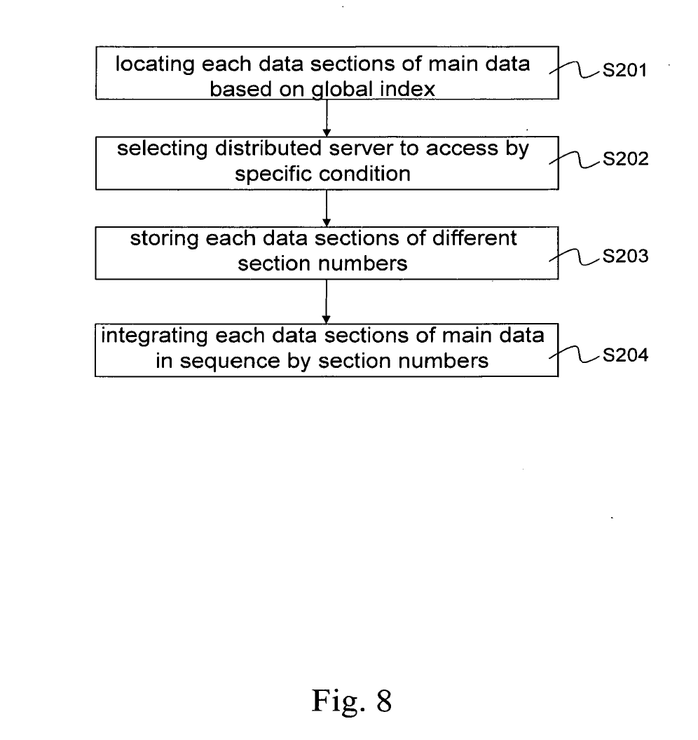

Please refer to FIGS. 7 and 8. Operation of the data stream management system 10 is described as below.

When a user wants to store a first video/audio file (main data) in a data stream management system 10 for other users to download, the user can transmit the first video/audio file to a main server 1001 through a client computer 170 (S101). In this embodiment, the first video/audio file has a size of 2.5 Mbytes. The main server 1001 will determine whether size of the first video/audio file exceeds 1 Mbytes (the predetermined size) (S102). The first video/audio file is then divided into three data sections because size of the first video/audio file exceeds 1 Mbytes, and the three data sections will be numbered as DA1, DA2 and DA3 (S103). If the first video/audio file has a size smaller than 1 Mbytes, then the main server 1001 will still consider it as one single data section (S104). Later, the main server 1001 will transmit the data sections DA1, DA2 and DA3 to distributed servers 1003, 1302 and 1502, respectively (S105). At the meantime, the main server 1001 will also update a current location of the data sections DA1, DA2 and DA3 in a global index (S106). Please refer to table 1, the global index includes at least one data section array. The data section array records corresponding relationship between each distributed servers 1001, 1002, 1003, 1004, 1301, 1302, 1501 and 1502 and data sections DA1, DA2 and DA3 (distributed servers stored with data sections are marked with a check symbol [symbol] ).

TABLE 1

| | 1001 | 1002 | 1003 | 1004 | 1301 | 1302 | 1501 | 1502 |
|---|---|---|---|---|---|---|---|---|
| DA1 | ◯ | | V | | | | | |
| DA2 | ◯ | | | | | V | | |
| DA3 | ◯ | | | | | | | V |

In the present embodiment, the first distributed server group 100 has a widest bandwidth and a highest transmission rate among the three distributed server groups 100, 130 and 150. The third distributed server group 150 has a narrowest bandwidth and a lowest transmission rate. Later, transmission rate difference will be put into consideration while describing difference on file browsing.

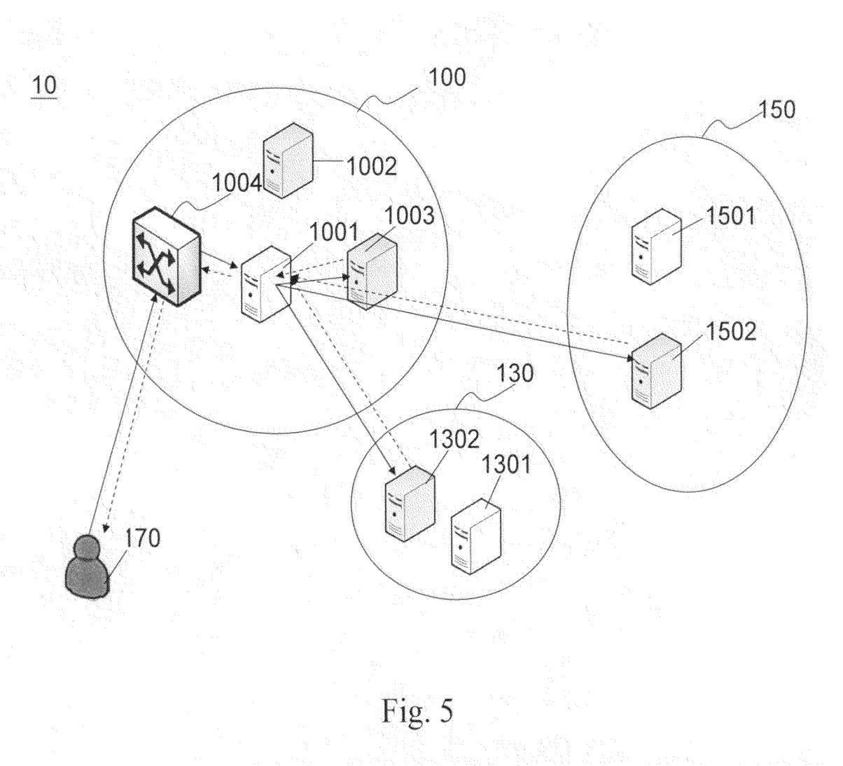

Please refer to FIG. 5, the client computer 170 will find a main server 1001 through a proxy server 1004 or directly contact the main server 1001 by the client computer 170 while the user wants to browse or download the first video/audio file from the data stream management system 10. First, the main server 1001 locates each data sections DA1, DA2 and DA3 of the first video/audio file based on the global index (table 1) and finds that the data sections are in servers 1003, 1302 and 1502 while the client computer 170 requests to receive the first video/audio file (S201). Then, select a distributed server to access the data sections by comparing transmission rate and completeness of data sections of the servers 1003, 1302 and 1502 (S202).

Since the data sections of the first video/audio file are equally distributed between servers 1003, 1302 and 1502, they can't be compared. Hence, please refer to table 2. Suppose there is a second video/audio file which is divided into four data sections and numbered as DB1, DB2, DB3 and DB4 by the main server 1501. The four data sections are stored in servers 1002 and 1003, 1003 and 1004, 1301 and 1502, respectively. Furthermore, a third video/audio file is divided into five data sections and numbered as DC1, DC2, DC3, DC4 and DC5 by the main server 1501. The five data sections are stored in servers 1003 and 1502, 1002, 1301, 1302 and 1004. In this case, the global index includes three data section arrays, as shown in table 2.

Since DB1 and DB2 are each stored in two different servers, the main server 1501 will select from one of the two servers that allows the data sections to be provided in a fastest way while the user wants to browse or download the second video/audio file from the main server 1501. Obviously, server 1003 is selected for access to DB1 and DB2 since server 1003 is stored with both DB1 and DB2. Meaning that server 1003 has a better completeness of data sections than servers 1002 and 1004. In another example, since DC1 and DC2 are each stored in two different servers, the main server 1501 will select from one of the two servers that allows the data sections to be provided in a fastest way while the user wants to browse or download the third video/audio file from the main server 1501. In this case, servers 1002 and 1003 will be selected for access of DC1 and DC2 due to the fact that the first distributed server group 100 has the widest bandwidth and the highest transmission rate among the three distributed server groups.

TABLE 2

| | 1001 | 1002 | 1003 | 1004 | 1301 | 1302 | 1501 | 1502 |
|---|---|---|---|---|---|---|---|---|
| DA1 | | | V | | | | | |
| DA2 | | | | | | V | | |
| DA3 | | | | | | | | V |
| DB1 | | V | V | | | | | |
| DB2 | | | V | V | | | | |
| DB3 | | | | | V | | | |
| DB4 | | | | | | | | V |
| DC1 | | | V | | | | | V |
| DC2 | | V | | | | | | |
| DC3 | | | | | V | | | |
| DC4 | | | | | | V | | |
| DC5 | | | | V | | | | |

Please refer to table 1 and FIG. 5. According to the present invention, the main server 1001 will keep a copy of each data sections of different section numbers (marked as ◯ in table 1) (S203). In other words, a main server may keep a copy of the data sections transmitted therethrough. Hence, each main server 1001, 1301 and 1501 might eventually have a copy of all of the data sections DA1, DA2 and DA3 of the first video/audio file during transmission if the first video/audio file is popular. By this way, the data stream management system 10 can provide a faster and adequate amount of data source to satisfy the increased demand. Finally, the main server 1001 will integrate each data sections DA1, DA2 and DA3 in sequence by section numbers to restore the first video/audio file (S204), and then provide it to the user.

Furthermore, the following points should also be notice regarding the present invention: 1. the amount of main server included in each distributed server groups is not limited to one, a distributed server group can include many main servers or the servers included in the distributed server group can all be main servers; 2. content of a data section can be fulfilled until it's size reaches the predetermined size while size of the main data or the data section is smaller than the predetermined size; 3. data sections are widely distributed to different distributed server groups, and are not one-to-one copied; 4. size of each data section arrays in the same distributed server groups are approximately the same, whereas would be different between different distributed server groups, due to the fact that the global index is dynamically updated by each main server.

While the invention has been described in terms of what is presently considered to be the most practical and preferred embodiment, it is understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A data stream management system for accessing mass data, comprising:
a client computer, for transmitting and receiving a main data; and
a plurality of distributed server groups, connected to the client computer via network, each of the distributed server groups including:
a determination unit, for determining whether size of the main data from the client computer exceeds a predetermined size;
a dividing unit, for dividing the main data into a plurality of data sections in a unit of the predetermined size and numbering the data sections into different section numbers while size of the main data exceeds the predetermined size, wherein the main data is considered as one date section while size of the main data is smaller than the predetermined size;
a plurality of distributed servers, for storing the data sections;
a transmitting unit, for transmitting the data sections to different distributed servers; and
a dispatching server, for controlling access of the distributed servers, and storing a global index for identifying in which distributed server each data sections is located.

2. The data stream management system according to claim 1, wherein the distributed server group further comprises an updating unit, for updating the global index of the distributed server group therein, and transmitting the updated global index to other updating units of other distributed server groups.

3. The data stream management system according to claim 2, wherein the updating unit updates the global index while the main data is transmitted or received by the client computer.

4. The data stream management system according to claim 2, wherein the updating unit updates the global index regularly.

5. The data stream management system according to claim 1, wherein the data section is distributed in different distributed servers of the distributed server groups.

6. The data stream management system according to claim 1, wherein the data section is randomly distributed in different distributed servers.

7. The data stream management system according to claim 1, further comprising an integrating unit, for locating each data sections of the main data based on the global index, selecting a distributed server to access by a specific condition, and integrating each data sections of the main data in sequence before providing to the client computer while the client computer requests to receive the main data.

8. The data stream management system according to claim 7, wherein the specific condition comprises transmission rate and completeness of the data sections.

9. The data stream management system according to claim 1, further comprising a proxy server having a memory, for accessing each data sections of the main data from the distributed server based on the global index, storing each data sections of different section numbers to the memory, and integrating each data sections of the main data in sequence by section numbers before providing to the client computer while the client computer requests to receive the main data.

10. The data stream management system according to claim 1, wherein the main data is a video/audio file.

11. The data stream management system according to claim 1, wherein the global index comprises at least one data section array.

12. A method for accessing mass data by a data stream management system according to claim 1, comprising the following steps:
a) transmitting a main data;
b) determining whether the size of the main data exceeds a predetermined size;
c) dividing the main data into a plurality of data sections in a unit of the predetermined size and numbering the data sections into different section numbers while size of the main data exceeds the predetermined size, wherein the main data is considered as one date section while size of the main data is smaller than the predetermined size;
d) transmitting the data sections to different distributed servers; and
e) updating a current location of each data sections in a global index.

13. The method according to claim 12, further comprising the following steps:
f) locating each data sections of the main data based on the global index while obtaining a request to receive the main data;
g) selecting a distributed server to access by a specific condition; and
h) integrating each data sections of the main data in sequence by section numbers.

14. The method according to claim 13, wherein the specific condition comprises transmission rate and completeness of the data sections.

15. The method according to claim 12, further comprises between steps g) and h) a step of storing each data sections of different section numbers.

16. The method according to claim 12, wherein the global index comprises at least one data section array.
